(19) United States
(12) Patent Application Publication
(10) Pub. No.: US 2016/0307656 A1
(43) Pub. Date: Oct. 20, 2016

(54) REMOVAL OF RADON IN AIR WITH ACTIVATED CARBON AND SELECTED ZEOLITE AND GILSONITE

(71) Applicant: Lance C. Smith, Paris, TN (US)

(72) Inventor: Lance C. Smith, Paris, TN (US)

(21) Appl. No.: 15/131,924

(22) Filed: Apr. 18, 2016

Related U.S. Application Data
(60) Provisional application No. 62/148,268, filed on Apr. 16, 2015.

(51) Int. Cl. G21F 9/02; B03C 3/60

(52) U.S. Cl. CPC G21F 9/02; B03C 3/60; B03C 2201/08

(57) ABSTRACT

A system for treating radon in the air including at least two carbon electrodes. Each carbon electrode is formed from a mixture of activated carbon, gilsonite, and zeolite which is extruded into the shape of an elongated rod. Positively-charged radon ions in the air are attracted to the electrodes. There is also provided a method for removing radioactive radon isotopes from the air including the steps of: (1) providing at least two carbon electrodes formed from activated carbon, gilsonite, and zeolite; and (2) initiating a chemical reaction between the activated carbon and the radioactive radon isotopes to half-life the radon isotopes into non-radioactive isotopes.

### CROSS REFERENCE TO RELATED APPLICATION

This application claims the benefit of U.S. Provisional Application 62/148,268, which was filed on Apr. 16, 2015, the disclosure of which is hereby incorporated by reference.

### BACKGROUND OF THE INVENTION

1. Field of the Invention

The present invention pertains to electrodes for removing radon from the air. More particularly, the present invention pertains to electrodes having activated carbon and zeolite for removing radioactive radon isotopes from the air.

2. Description of the Prior Art

Radon (Rn) and air-ions are two highly correlated biologically active constituents of outdoor and indoor air. Air-ion concentration (n^{±}) in the lower troposphere are determined mostly by airborne radionuclides and external sources, i.e. cosmic radiation and radioactivity that originates from the radioactive minerals from the earth's crust. At sea level up to a few hundred meters, cosmic rays contribute approximately 20% of total surface air-ion production rate that is typically 10 cm⁻³s⁻¹. According to a representative shielding factor of buildings on cosmic radiation charged particles and photons in 0.8 after the radiation has passed through a substantial ceiling. The second external source of air-ions is y radiation from U, Th and U decay series and primordial radionuclide as K. These are the most stable sources of air-ion production and considered as almost constant during the day, because their variation is very small compared to Rn and its progenies decay. Major inducement of variation of the air-ion pair production is due to changes in Rn exhalation and atmospheric mixing processes.

Rn is an inert and radioactive soil gas descending from uranium. U decay series with a half-life of 3.82 days. Rn α-decay is followed by a series of four further decays with half-lives less than 30 min each. Po (α particle), Pb (α particle), Bi (β particle), and Po (β particle).

The radioactive decay of inhaled short-lived radon progeny in the respiratory tract results in the deposition of α-energy in the cells of the bronchial epithelium. Decay products can cause direct effect on DNA structure and indirect effect due to the production of active chemical radicals in the vicinity of DNA. The risk estimates obtained in the study suggest that cumulative Rn exposure in the residential environment is significantly associated with lung cancer risk. It is estimated that Rn contributes around 50% of background radiation dose received by general population.

Radon is a gas 7.5 times heavier than air; when generated in Earth's crust, it penetrates the pores in the ground and moves upward by diffusion and convection toward the surface and into the air. This process is called exhalation and its rate depends on air pressure and also permeability, thermal gradient and humidity of the soil. In the atmosphere Rn appears mostly in the vicinity of its source, i.e., ground and its transport is determined by thermal processes. When exhaling in the indoor space, Rn is prone to accumulation. Rn entrance and accumulation in residencies and offices is related to many local and time dependent factors such as uranium content of the underlying soil, construction material, permeability and number of cracks in the basement shell, ventilation conditions, radioactivity in the air outdoors and meteorological parameters. Indoor sources of Rn and soil or rocks under or surrounding the buildings, construction materials, water supplies, natural gas and outdoor air. Annual indoor air action level of Rn concentration above which remediation should be considered varies from country to country. According to ICRP (International Commission on Radiological Protection) recommendation, it is between 200 and 600 Bq/m³, where 1 Bq=1 decay/s and Rn activity concentration is activity/volume. Evaluation of the Rn concentration in indoor spaces is very important where the underlying geology, soils or building materials are intensive Rn sources. High Rn concentrations are measured in the old houses without concrete floor and hydro-insulation especially if ventilation is not intensive. Also, construction materials can be sources of Rn and thoron radionuclides in the indoor air.

Thoron (Rn) is noble gas from thorium (Th) decay chain with relatively short half-life of 55.6 s. Thoron exhales from the ground and walls in the same way as radon but in general has a lower concentration. In indoor space, thoron exhales from the building materials that contain radium (Ra). Although thoron concentration decreases exponentially from the source, its contribution to air-ion pair production due to a-decay remains

The majority of the dose is caused by the decay of the polonium (Po) and lead (Pb) daughters from Rn. It is the case that by controlling the daughters that the dose to the skin and lungs can be reduced by at least 90%. This can be done by wearing a dust mask, and wearing a suit to cover the entire body. Note that exposure to smoke at the same time as radon and radon daughters will increase the harmful effect of the radon. In uranium miners radon has been found to be more carcinogenic in smokers that in non-smokers.

On average, there is one atom of radon in 1×10²¹ molecules of air. Radon can be found in some spring water and hot springs. The towns of Misasa, Japan, and Bad Kreuznach, Germany boast radium-rich springs which emit radon. Unsurprisingly, Radium Springs, N. Mex. does too.

Radon exhausts naturally from the ground, particularly in certain regions, especially but not only regions with granitic soils. Not all granitic regions are prone to high emissions of radon, for instance while the rock which Aberdeen is on is very radium rich the rock lacks the cracks required for the radon to migrate. In other nearby areas of Scotland (to the north of Aberdeen) and in Cornwall/Devon the radon is very able to leave the rock.

Radon is a decay product of radium which in turn is a decay product of uranium. It is possible to acquire maps of average radon levels in houses to assist in the planning of radon mitigation measures for homes. Note that while high uranium in the soil/rock under a house does not always lead to a high radon level in air, a positive correlation between the uranium content of the soil and the radon level in air can be seen.

Radon is related to Indoor air quality as it blights many homes. The radon (Rn) released into the air decays to Pb and other radioisotopes, the levels of Pb can be measured. It is important to note that the rate of deposition of this radioisotope is very dependent on the season.

Well water can be very rich in radon; the use of this water inside a house is an additional route allowing radon to enter the house. The radon can enter the air and then be a source of exposure to the humans, or the water can be consumed by humans which is a different exposure route.

Rainwater can be intensely radioactive due to high levels of radon and its decay progeny Bi & Pb; the concentrations of these radioisotopes can be high enough to seriously disrupt radiation monitoring at nuclear power plants. The highest levels of radon in rainwater occurs during thunderstorms on account of the atom's positive electrical charge. Estimates of the age of rain drops have been obtained from measuring the isotopic abundance of radon's short-lived decay progeny in rainwater.

The water, oil and gas from a well often contains radon. The radon decays to form sold radioisotopes which form coatings on the inside of the pipework. In an oil processing plant the area of the plant where propane is processed is often one of more contaminated areas of the plant as radon has a similar boiling point to propane.

Because uranium minerals emit radon gas, and their harmful and highly radioactive daughter products, uranium mining is considerably more dangerous than other (already dangerous) hard rock mining, requiring adequate ventilation systems if the mines are not open pit. During the 1950's, a significant number of American uranium miners were Navajo Indians, as many uranium deposits were discovered on Navajo reservations. A statistically significant subset of these miners later developed small-cell lung cancer, a type of cancer usually not associated with smoking, after exposure to uranium ore and radon-222, a natural decay product of uranium. The radon, which is produced by the uranium, and not the uranium itself has been shown to be the cancer causing agent. Some survivors and their descendants received compensation under the Radiation Exposure Compensation Act in 1990.

Currently the level of radon in the air of mines is normally controlled by law. In a working mine, the radon level can be controlled by ventilation, sealing off old workers and controlling the water in the mine The level in a mine can go up when a mine is abandoned, it can reach a level which is able to cause the skin to become red (a mild radiation burn). The radon levels in some of the mines can reach 400 to 700 kBq/m³.

A common unit of exposure of lung tissue to alpha emitters is the Working level month (WLM), this is where the human lungs have been exposed for 170 hours (a typical month worth of work for a miner) to air which has 3.7 kBq/m³ of Rn (in equilibrium with its decay products). This is air which has the alpha dose rate of 1 working level (WL). It is estimated that the average person (general public) is subject to 0.2 WLM per year, which works out at about 15 to 20 WLM in a lifetime. According to the NRC 1 WLM is a 5 to 10 mSv lung dose (0.5 to 1.0 rem), while the OECD consider that 1 WLM is equal to a lung dose of 5.5 mSv, the ICRP consider 1 WLM to be a 5 mSv lung dose for professional workers (and 4 mSv lung dose for the general public). Lastly the UN (UNSCEAR) consider that the exposure of the lungs to 1 Bq/m³ of Rn (in equilibrium with its decay products) for one year will cause a dose of 61 μSv.

This overview of the working level month is based upon the book by Jiri Hála and James D. Navratil (ISBN 80-7302-053-X).

In humans a relationship between lung cancer and radon has been shown at exist (beyond all reasonable doubt) for exposures of 100 WLM and above. By using the data from several studies it has been possible to show that an increased risk can be caused by a dose as low as 15 to 20 WLM. Sadly these studies have been difficult as the random errors in the data are very large. It is likely that the miners are also subject to other effects which can harm their lungs while at work (for example dust and diesel fumes).

The danger of radon exposure in dwellings was discovered in 1984 by Stanley Watras, an employee at the Limerick nuclear power plant in Pennsylvania. Mr. Watras set off the radiation alarms (see Geiger counter) on his way into work for two weeks straight while authorities searched the source of the contamination. They were shocked to find out that the source was astonishingly high levels of Radon in his basement and it was not related to the nuclear plant. The risks associated with living in his house were estimated to be equivalent to smoking 135 packs of cigarettes every day.

Depending on how houses are built and ventilated, radon may accumulate in basements and dwellings The European Union recommends that action should be taken starting from concentrations of 400 Bq/m³ for old houses, and 200 Bq/m³ for new ones.

The National Council of Radiation Protection and Measurements (NCRP) recommends action for any house with a concentration higher than 8 pCi/1 (300 Bq/m³).

The United States Environmental Protection Agency recommends action for any house with a concentration higher than 148 Bq/m³ (given as 4 pCi/1). Nearly one in 15 homes in the U.S. has a high level of indoor radon according to their statistics. The U.S. Surgeon General and EPA recommend all homes be tested for radon. Since 1985, millions of homes have been tested for radon in the U.S.

By adding a crawl space under the ground floor, which is subject to forced ventilation the radon level in the house can be lowered.

Radon is a colorless and odorless gas, and therefore not detectable by human senses alone. At standard temperature and pressure, radon forms a monoatomic gas with a density of 9.73 kg/m³, about 8 times the density of the Earth's atmosphere at sea level, 1.217 kg/m³. Radon is one of the densest gases at room temperature and is the densest of the noble gases. Although colorless at standard temperature and pressure, when cooled below its freezing point of 202K (−17° C.; −96° F.), radon emits a brilliant phosphorescence that turns from yellow to orange-red as the temperature lowers. Upon condensation, radon glows because of the intense radiation it produces.

Being a noble gas, radon is chemically not very reactive. However, the 3.8 day half-life of radon-222 makes it useful in physical sciences as a natural tracer.

Radon is a member of the zero-valence elements that are called noble gases. It is inert to most common chemical reactions, such as combustion, because the outer valence shell contains eight electrons. This produces a stable, minimum energy configuration in which the outer shell are tightly bound. 1037 kJ/mol is required to extract one electron from its shells (also known as the first ionization energy). However, in accordance with periodic trends, radon has a lower electro negativity than the element one period before it, xenon, and is therefore more reactive. Radon is sparingly soluble in water, but more soluble than lighter noble gases. Radon is appreciably more soluble in organic liquids than in water. Early studies concluded that the stability of radon hydrate should be of the same order as that of the hydrates of chlorine (Cl₂) or sulfur dioxide (SO₂), and significantly higher than the stability of the hydrate of hydrogen sulfide(H₂S).

Because of its cost and radioactivity, experimental chemical research is seldom performed with radon, and as a result there are very few reported compounds of radon, all either fluorides or oxides. Radon can be oxidized by a few powerful oxidizing agents such as fluorine, thus forming radon fluoride. It decomposes back to elements at a temperature of above 250° C. It has a low volatility and was thought to be RnF₂. But because of the short half-life of radon and the radioactivity of its compounds, it has not been possible to study the compound in any detail Theoretical studies on this molecule predict that it should have a Rn—F bond distance of 2.08 Å, and that the compound is thermodynamically more stable and less volatile than its lighter counterpart XeF₂. The octahedral molecule RnF₆ was predicted to have an even lower enthalpy of formation than the difluoride. The [RnF]⁺ ion is believed to form by the reaction:

Rn (g)+2[O₂]⁺[SbF₆]⁻(s)→[RnF]⁺(s)+2 O₂(g)

Radon oxides are among the few other reported compounds of radon. Radon carbonyl RnCO has been predicted to be stable and to have a linear molecular geometry. The molecules Rn₂ and RnXe were found to be significantly stabilized by spin-orbit coupling. Radon caged inside a fullerene has been proposed as a drug for tumors.

Pb is formed from the decay of ²²²Rn. Here is a typical deposition rate of ²¹⁰Pb as observed in Japan as a function of time, due to variations in radon concentration.

Radon concentration is usually measured in the atmosphere in becquerels per cubic meter (Bq/m³), which is an SI derived unit. As a frame of reference, typical domestic exposures are about 100 Bq/m³ indoors and 10-20 Bq/m³ outdoors. In the US, radon concentrations are often measured in picocuries per liter (pCi/l), with 1 pCi/l=37 Bq/m³.

The mining industry traditionally measures exposure using the working level (WL) index, and the cumulative exposure in working level months (WLM): 1 WL equals any combination of the short-lived ²²²Rn progeny (²¹⁸Po , ²¹⁴Pb, ²¹⁴Bi, and ²¹⁴Po) in 1 liter of air that releases 1.3×10⁵ MeV of potential alpha energy; one WL is equivalent to 2.08×10⁵ joules per cubic meter of air (J/m³). The SI unit of cumulative exposure is expressed in joule-hours per cubic meter (J.h/m³). One WLM is equivalent to 3.6×10⁻³ J.h/m³. An exposure to 1 WL for 1 working month (170 hours) equals 1 WLM cumulative exposure.

A cumulative exposure of 1 WLM is roughly equivalent to living one year in an atmosphere with a radon concentration of 230 Bq/m³.

The radon (²²²Rn) released into the air decays to ²¹⁰Pb and other radioisotopes. The levels of ²¹⁰Pb can be measured. The rate of deposition of this radioisotope is dependent on the weather.

Radon concentrations found in natural environments are much too low to be detected by chemical means, for example, a 1000 Bq/m³ (relatively high) concentration corresponds to 0.17 pico-grams per cubic meter. The average concentration of radon in the atmosphere is about 6×10⁻²⁰ atoms of radon for each molecule in the air, or about 150 atoms in each ml of air. The entire radon activity of the Earth's atmosphere at a time is due to some tens of grams of radon, consistently replaced by decay of larger amounts of radium and uranium. In reality, [clarification needed] concentrations can vary greatly from place to place. In the open air, it ranges from 1 to 100 Bq/m³, even less (0.1 Bq/m³) above the ocean. In caves, aerated mines, or in poorly ventilated dwellings, its concentration can climb to 20-2,000 Bq/m³.

In mining contexts, radon concentrations can be much higher. However, ventilation regulations try to maintain concentrations in uranium mines under the “working level”, and under 3 WL (546 pCi Rn per liter of air; 20.2 kBq/m³ measured from 1976 to 1985) 95 percent of the time. The concentration in the air at the (unventilated) Gastein Healing Gallery averages 43 kBq/m³ (about 1.2 pCi/L) with maximal value of 160 kBq/m³ (about 4.3 pCi/L).

Radon emanates naturally from the ground and from some building materials all over the world, wherever traces of uranium or thorium can be found, and particularly in regions with soils containing granite or shale, which have a higher concentration of uranium. In fact, every square mile of surface soil, to a depth of 6 inches (2.6 km² to a depth of 15 cm), contains approximately 1 gram of radium, which releases radon in small amounts to the atmosphere. On a global scale, it is estimated that 2,400 million curies (91 Tbq/m³) of radon are released from soil annually However, not all granitic regions are prone to high emissions of radon. Being a rare gas, it usually migrates freely through faults and fragmented soils, and may accumulate in caves or water. Due to its very small half-life (four days for Rn), its concentration decreases very quickly when the distance from the production area increases. Its atmospheric concentration varies greatly depending on the season and conditions. For instance, it has been shown to accumulate in the air if there is a meteorological inversion and little wind.

Because atmospheric radon concentrations are very low, radon-rich water exposed to air continually loses radon by volatilization. Hence, ground water has generally has higher concentrations of ²²²Rn than surface water, because the radon is continuously produced by radioactive decay of ²²⁶Ra present in rocks. Likewise, the saturated zone of a soil frequently has a higher radon content than the unsaturated zone because of diffusional losses to the atmosphere. As a below-ground source of water, some springs—including hot springs—contain significant amounts of radon. The towns of Boulder, Mont.; Misasa; Bad Kreuznach, Germany; and the country of Japan have radium-rich springs which emit radon. To be classified as a radon mineral water, radon concentration must be above a minimum of 2 pCi/l (74 Bq/m³). The activity of radon mineral water reaches 2,000 Bq/m³ in Merano and 4,000 Bq/m³ in Lurisia (Italy).

Radon is also found in some petroleum. Because radon has a similar pressure and temperature curve as propane, and oil refineries separate petrochemicals based on their boiling points, the piping carrying freshly separated propane in oil refineries can become partially radioactive due to radon decay particles. Residues from the oil and gas industry often contain radium and its daughters. The sulfate scale from an oil well can be radium rich, while the water, oil, and gas from a well often contains radon. The radon decays to form solid radioisotopes which form coatings on the inside of pipework. In an oil processing plant, the area of the plant where propane is processed is often one of the more contaminated areas, because radon has a similar boiling point as propane.

Radon has no stable isotopes. However, 36 radioactive isotopes have been characterized, with their atomic masses ranging from 193 to 228. The most stable isotopes ²²²Rn, which is a decay product of ²²⁶Ra, a decay product of ²³⁸U. Among the daughters of ²²²Rn is also the highly unstable isotope ²¹⁸Rn. There are three other radon isotopes that have a half-life of over an hour: ²¹¹Rn, ²¹⁰Rn and ²²⁴Rn. The ²²⁰Rn isotope is a natural decay product of the most stable thorium isotope (²³²Th), and is commonly referred to as thoron. It has a half-life off 55.6 seconds and also emits alpha radiation. Similarly, ²¹⁹Rn is derived from the most stable isotope of actinium (²²⁷Ac)—named “actinon”—and is an alpha emitter with a half-life of 3.96 seconds. No radon isotopes occur significantly in the neptunium (²³⁷Np) decay series.

An important question is if also passive smoking can cause a similar synergy effect with residential radon. This has been insufficiently studied. The basic data for the European pooling study makes it impossible to exclude that such synergy effect is an explanation for the (very limited) increase in the risk from radon that was stated for non-smokers. A study from 2001, which included 436 cases (never smokers who had lung cancer), and a control group (1649 never smokers) showed that exposure to radon increased the risk of lung cancer in never smokers. But the group that had been exposed to passive smoking at home appeared to bear the entire risk increase, while those who were not exposed to passive smoking did not show any increased risk with increasing radon level. This result needs confirmation by additional studies. Despite the startling results from 2001, new studies seem not to have been implemented.

The effects of radon if ingested are similarly unknown, although studies have found that its biological half-life ranges from 30-70 minutes, with 90 percent removal at 100 minutes. In 1999 National Research Council investigated the issue of radon in drinking water. The risks associated with ingestion was considered almost negligible.

As well as being ingested through drinking water, radon is also released from water when temperature is increased, pressure is decreased and when water is aerated. Optimum conditions for radon release and exposure occur during showering. Water with a radon concentration of 10⁴ pCi/l can increase the indoor airborne radon concentration by 1 pCi/l under normal conditions of water use.

Radon is saturating our whole planet and is causing cancers; primarily lung cancers and secondarily skin cancers. More technical data is available through the U.S. Environmental Protection Agency.

Thus, there remains a need for a radon mitigation or removal system which is inexpensive and easy to install and implement, yet which remains effective at removing harmful radon isotopes from the air.

The present invention, as is detailed hereinbelow, seeks to fill this need by providing electrodes having activated carbon and zeolite for removing radioactive radon isotopes from the air.

### SUMMARY OF THE INVENTION

Physical adsorption is the primary means by which activated carbon works to remove contaminants from water. Carbon's highly porous nature provides a large surface area for contaminants (adsorbates) to collect. In simple terms, physical adsorption occurs because all molecules exert attractive forces, especially molecules at the surface of a solid (pore walls of carbon), and these surface molecules seek other molecules to adhere to.

The large internal surface area of carbon has many attractive forces that work to attract other molecules. Thus, contaminants in water are adsorbed (or held) to the surface of carbon by surface attractive forces similar to gravitational forces. Adsorption from solution occurs as a result of differences in adsorbate concentration in the solution and in the carbon pores.

The adsorbate migrates from the solution through the pore channels to reach the area where the strongest attractive forces are. With this understanding of how the adsorption process works, we must then understand why it works, or why water contaminants become adsorbates. Water contaminants adsorb because the attraction of the carbon surface for them is stronger than the attractive forces that keep them dissolved in the solution.

The present invention provides a system for treating radon in the air comprising:
at least two carbon electrodes, each carbon electrode being formed from a mixture of activated carbon, gilsonite, and zeolite, the mixture of activated carbon, gilsonite, and zeolite being mixed together and extruded into a rod; whereby positively-charged radon ions in the air are drawn to the carbon electrodes.

The present invention also provides a method for removing radioactive radon isotopes from the air including the steps of:
providing at least two carbon electrodes formed from activated carbon, gilsonite, and zeolite; and
initiating a chemical reaction between the activated carbon and the radioactive radon isotopes to half-life the radon isotopes into non-radioactive isotopes.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a perspective view showing an electrode of a first embodiment of the present invention hereof;

FIG. 2 is a perspective view showing a base for standing an electrode vertically; and

FIG. 3 is an environmental view showing two electrodes in the presence of a radon detector.

### DETAILED DESCRIPTION OF THE INVENTION

Physical adsorption is the primary means by which activated carbon works to remove contaminants from water. Carbon's highly porous nature provides a large surface area for contaminants (adsorbates) to collect. In simple terms, physical adsorption occurs because all molecules exert attractive forces, especially molecules at the surface of a solid (pore walls of carbon), and these surface molecules seek other molecules to adhere to.

The large internal surface area of carbon has many attractive forces that work to attract other molecules. Thus, contaminants in water are adsorbed (or held) to the surface of carbon by surface attractive forces similar to gravitational forces. Adsorption from solution occurs as a result of differences in adsorbate concentration in the solution and in the carbon pores.

The adsorbate migrates from the solution through the pore channels to reach the area where the strongest attractive forces are. With this understanding of how the adsorption process works, we must then understand why it works, or why water contaminants become adsorbates. Water contaminants adsorb because the attraction of the carbon surface for them is stronger than the attractive forces that keep them dissolved in the solution.

Those compounds that are more adsorbable onto activated carbon generally have a lower water solubility, are organic (made up of carbon atoms), have a higher molecular weight and a neutral or non-polar chemical nature. It should be pointed out that for water adsorbates to become physically adsorbed onto activated carbon, they must be both dissolved in water and smaller than the size of the carbon pore openings so that they can pass into the carbon pores and accumulate.

Besides physical adsorption, chemical reactions can occur on a carbon surface. One such reaction is chlorine removal from water involving the chemical reaction of chlorine with carbon to form chloride ions. This reaction is important to POU treatment because this conversion of chlorine to chloride is the basis for the removal of some common objectionable tastes and odors from drinking water. Water contaminants adsorb because the attraction of the carbon surface for them is stronger than the attractive forces that keep them dissolved in solution.

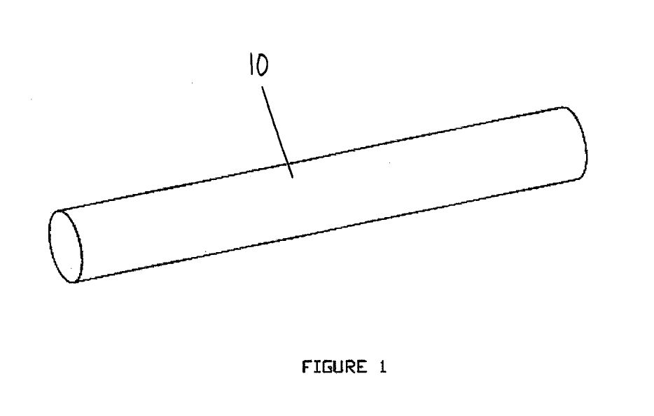

FIG. 1 shows a single extruded electrode rod 10 made up of carbon, zeolite and gilsonite. The electrode rod 10 is formed by creating an admixture of activated carbon, zeolite, and gilsonite. The admixture is then extruded into an elongated form, such as a rod. The electrode rod 10 is shown as being cylindrical in shape, but any suitable shape which generally maximizes surface area can be used. The electrode rod 10 can be any suitable length, but preferably the electrode rod 10 is about eight inches long.

As understood by those having ordinary skill in the art, activated carbon, also known as activated charcoal, is a form of carbon process to have small, low-volume pores that significantly increase the surface area available for adsorption and chemical reactions. The activated carbon is preferably in a powder form when it is added to the admixture.

The admixture also includes gilsonsite, which is a tarry substance used for cement bonding. The gilsonite functions as a bonding agent for the activated carbon and zeolite and provides the stability and structure to the electrode rod 10.

The admixture further includes zeolite. As understood by those having ordinary skill in the art, zeolite is an adsorber of the radon isotope Rn²²².

In the preferred embodiment, at least two electrode rods 10,10′ are spaced apart within an application area. Radon gas within the application area is ionized as it passes between two electrodes. Alternatively, the radon is already ionized. Through this ionization of the gas and by the adsorption activity of the activated carbon the radon is brought to each electrode where the zeolite then adsorbs the toxic radon isotope Rn²²². Rn²²² is then half-lifed and no longer radioactive. This chemical reaction is referred to as a fissing process in nuclear physics.

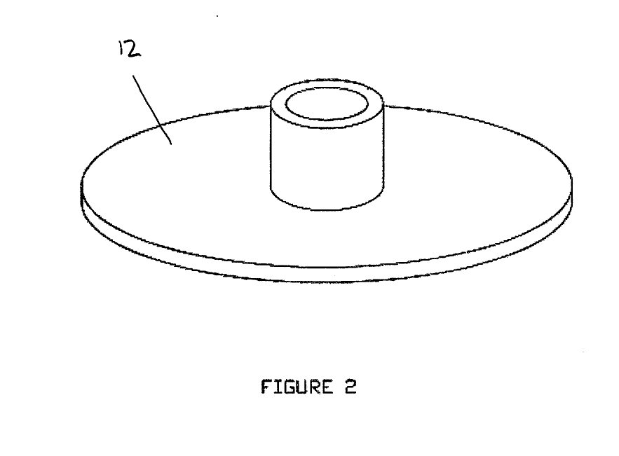

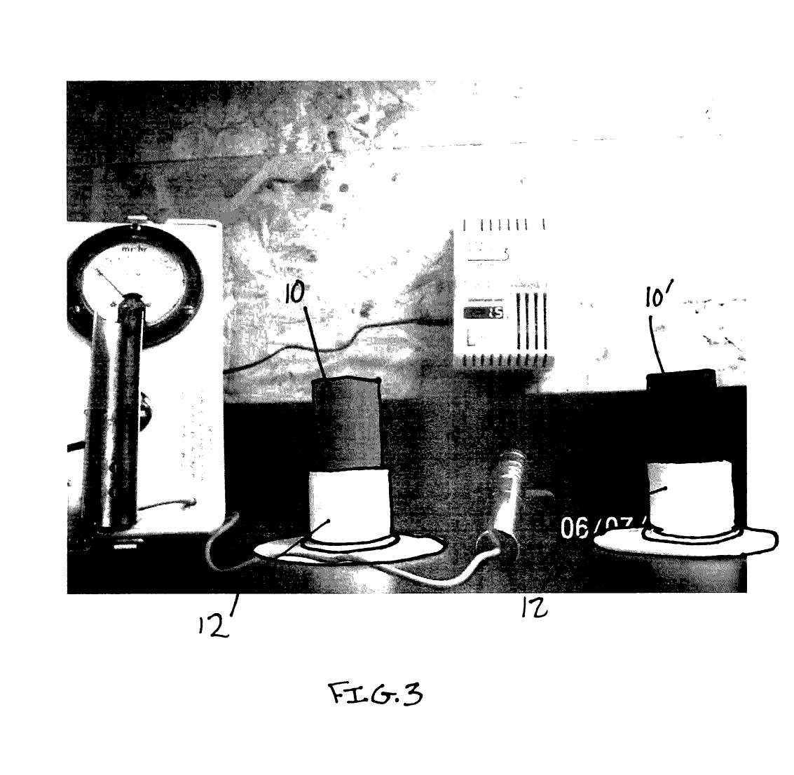

Optionally, the electrode rod 10 can be supported vertically in a base 12, such as shown in FIGS. 2 and 3. The base 12 is preferably formed from a non-conductive material, such as a plastic polymer.

The present invention provides a system for treating radon in the air comprising: (a) at least two carbon electrodes, each carbon electrode being formed from a mixture of activated carbon, gilsonite, and zeolite, the mixture of activated carbon, gilsonite, and zeolite being mixed together and extruded into a rod; and whereby the positively-charged radon ions in the air are drawn to the carbon electrodes.

The present invention also provides a method for removing radioactive radon isotopes from the air including the steps of: (a) providing at least two carbon electrodes formed from activated carbon, gilsonite, and zeolite; and (b) initiating a chemical reaction between the activated carbon and the radioactive radon

As is apparent from the preceding, the present invention provides a system and method for removing radon from the air.

What is claimed is:

1. A system for treating radon in the air comprising:
at least two carbon electrodes, each carbon electrode being formed from a mixture of activated carbon, gilsonite, and zeolite, the mixture of activated carbon, gilsonite, and zeolite being mixed together and extruded into a rod; and whereby positively-charged radon ions in the air are drawn to the carbon electrodes.

2. The system of claim 1 wherein the carbon and zeolite are in a powderized form.

3. The system of claim 1 wherein the electrodes are about eight inches long.

4. A method for removing radioactive radon isotopes from the air including the steps of:
providing at least two carbon electrodes formed from activated carbon, gilsonite, and zeolite; and
initiating a chemical reaction between the activated carbon and the radioactive radon isotopes to half-life the radon isotopes into non-radioactive isotopes.
